(19) United States
(12) Patent Application Publication
(10) Pub. No.: US 2019/0034454 A1
(43) Pub. Date: Jan. 31, 2019

(54) EXPANDABLE TREE-BASED INDEXING FRAMEWORK THAT ENABLES EXPANSION OF THE HADOOP DISTRIBUTED FILE SYSTEM

(71) Applicant: Intel Corporation, Santa Clara, CA (US)

(72) Inventors: Uma Maheswara Rao Gangumalla, Santa Clara, CA (US); Malini Bhandaru, San Jose, CA (US); Rakesh Radhakrishnan Potty, Bangalore (IN); Devarajulu Kavali, Santa Clara, CA (US); Niraj Rai, Los Altos Hills, CA (US)

(73) Assignee: Intel Corporation, Santa Clara, CA (US)

(21) Appl. No.: 15/847,336

(22) Filed: Dec. 19, 2017

(51) Int. Cl. G06F 17/30

(52) U.S. Cl. CPC G06F 17/30221; G06F 17/30327; G06F 17/30091

(57) ABSTRACT

Disclosed is a file system that may support data management for a distributed data storage and computing system, such as Apache™ Hadoop®. The file system may include an expandable tree-based indexing framework that enables convenient expansion of the file system. As a non-limiting example, the file system disclosed herein may enable indexing, storage, and management of a billion or more files, which is 1,000 times the capacity of currently available file systems. The file system includes a root index system and a number of leaf index systems that are organized in a tree data structure. The leaf index systems provide heartbeat information to the root index system to enable the root index system to maintain a lightweight and searchable index of file references and leaf index references. Each of the leaf indexes maintains an index or mapping of file references to file block addresses within data storage devices that store files.

### FIELD

The present disclosure relates to techniques for improving file system capacity of distributed processing systems.

### BACKGROUND

Technologies that perform “big data” operations regularly use the Apache™ Hadoop® Distributed File System platform or other distributed file systems to manage their data. Distributed file systems are useful in big data operations because they enable remote access and shared access to data from a variety of applications and client devices, and can cope with large volumes of data. In the emerging automation fields, such as self-driving vehicles, more data needs to be managed than ever before. However, traditional data management systems are constrained by existing architectures in the number of files that can be managed. Such constraints currently limit technological advances.

### BRIEF DESCRIPTION OF DRAWINGS

Features and advantages of the claimed subject matter will be apparent from the following detailed description of embodiments consistent therewith, which description should be considered with reference to the accompanying drawings, wherein:

FIG. 1 illustrates a functional block diagram of a data management system having a file system framework that may support a distributed processing system consistent with several embodiments of the present disclosure;

FIG. 2 illustrates a functional block diagram of a data management system having a file system framework that may support a distributed processing system consistent with several embodiments of the present disclosure;

FIG. 3 is a flowchart of a process for operations of a data management system having a file system framework that may support a distributed processing system consistent with several embodiments of the present disclosure; and

FIG. 4 is a flowchart diagram of a process for providing a tree-based indexing framework that enables expansion of a file system consistent with several embodiments of the present disclosure.

Although the following Detailed Description will proceed with reference being made to illustrative embodiments, many alternatives, modifications, and variations thereof will be apparent to those skilled in the art.

### DETAILED DESCRIPTION

A system, apparatus and/or method provide a file system that may support data management for a distributed data processing system, such as Apache™ Hadoop. The file system may include an expandable tree-based indexing framework that enables convenient expansion of the file system. As a non-limiting example, the file system disclosed herein may enable indexing, storage, and management of a billion or more files, which is 1,000 times the capacity of currently available file systems. The file system includes a root index system and a number of leaf index systems that are organized in a tree data structure. The leaf index systems provide heartbeat information to the root index system to enable the root index system to maintain a lightweight and searchable index of file references and leaf index references. Each of the leaf indexes maintains an index or mapping of file references to file block addresses within data storage devices that store files. In terms of the Apache™ Hadoop® file system, the root index system may be a root namenode, the leaf index system may be a leaf namenode, and the data storage devices may be datanodes.

The disclosed file system may provide advantages over existing file system solutions because the disclosed file system provides improved scalability, capacity, speed, and/or usability of the file system. The root index system receives access requests from client devices to read files, write files, update, delete or otherwise access the data storage devices. The root index system determines which leaf index system(s) manage the files or directories of the access requests, and notify the client devices of which leaf index systems to communicate with to arrange the access request. The client device requests, from the relevant leaf index system(s), data storage device information (e.g., data block addresses) for the files or directories of the access request. The relevant leaf index system provides the client devices with data block addresses, data storage device addresses, and/or other file metadata to support read requests, write requests, or other access requests, according to one embodiment. The client devices use the data block addresses, the data storage device addresses, and/or the other file metadata to communicate directly with one or more data storage devices to read files, write files, and/or otherwise perform access operations on the data storage devices, according to various embodiments.

As used herein, a root namenode (“RNN”) may refer to a system component or module that generates, maintains, and updates a directory tree of all of the files in the file system, and tracks which leaf namenode manages each file. A root namenode does not store the data of these files and does not track the actual locations of the files within datanodes, and instead stores pointers or other metadata of the files (e.g., file references) and stores information (e.g., a leaf namenode reference) about which leaf namenode is associated with or manages each of the files.

As used herein, a leaf namenode (“LNN”) may refer to a system component or module that generates, maintains, and updates a directory tree of files (e.g., all or partial) in the file system, and tracks where the file data is stored (e.g., which datanode and/or which block files in one or more datanodes). A leaf namenode does not store the data of these files, and instead stores pointers or other metadata of the files (e.g., file references) with datanode information (e.g., datanode name, datanode address, block file address).

As used herein, a datanode refers to one or more data storage devices that stores the data for the files referenced by the root namenode and the leaf namenodes.

As used herein, data block or a block refers to a raw storage volume filled with files or portions of files that have been split into chunks of data of equal size. Data blocks or blocks are used to support operation of block-based or block level storage (as compared to file-based storage).

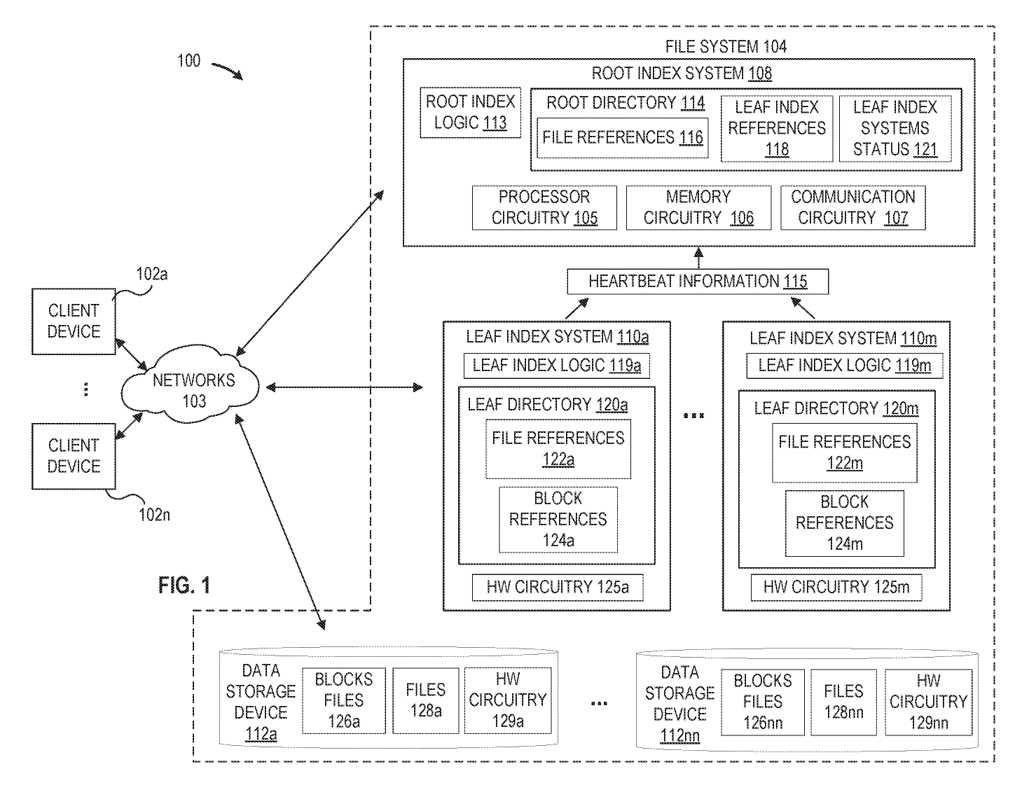

FIG. 1 illustrates a functional block diagram of data management system 100 having a file system framework that may support a distributed data processing system consistent with several embodiments of the present disclosure. The data management system 100 includes client devices 102 (individually, client device 102a through client device 102n) communicatively coupled through one or more networks 103 to a file system 104, according to one embodiment.

The client devices 102 and the file system 104 may include, but are not limited to, a mobile telephone including, but not limited to a smart phone (e.g., iPhone®, Android®-based phone, Blackberry®, Symbian®-based phone, Palm®-based phone, etc.); a wearable device (e.g., wearable computer, “smart” watches, smart glasses, smart clothing, etc.) and/or system; an Internet of Things (IoT) networked device including, but not limited to, a sensor system (e.g., environmental, position, motion, etc.) and/or a sensor network (wired and/or wireless); a computing system (e.g., a server, a workstation computer, a desktop computer, a laptop computer, a tablet computer (e.g., iPad®, GalaxyTab® and the like), an ultraportable computer, an ultramobile computer, a netbook computer and/or a subnotebook computer; etc.

The file system 104 includes a root index system 108 and a number of leaf index systems 110 (individually, leaf index system 110a through leaf index system 110m) to provide an expandable file system framework that manages access to data stored in data stores 112 (individually, data store 112a through data store 112nn), according to one embodiment. The file system 104 may be agnostic of memory-based systems or file-based systems, according to one embodiment. The file system 104 may use block level storage techniques to store, maintain, write, and/or access files in the data stores 112, according to one embodiment. The root index system 108 and the leaf index systems 110 may individually or collectively be launched on bare metal nodes, virtual machines, or containers, according to various embodiments. The virtual machines and containers may be cloud solutions. In one embodiment, the root index system 108 and the leaf index systems 110 may all be on a single physical computing system or node, for example, for test and/or development purposes.

And even all in one on a single physical node for test and development scenarios

The root index system 108 includes root index logic 113 and a root directory 114. The root index logic 113 includes instructions that are stored in memory circuitry 106 and executed by processor circuitry 105 to generate and/or update the root directory 114, according to one embodiment. The root index system 108 may use communication circuitry 107 to communicate with the number of leaf systems 110 and/or with the client devices 102, through the one or more networks 103. Generating and/or updating the root directory 114 includes receiving heartbeat information 115 from the leaf index systems 110, according to one embodiment. The heartbeat information 115 includes information about the leaf index systems 110 such as, but not limited to, online/offline status, available capacity, and file references and/or block (or memory) references maintained by each of the index systems 110, according to one embodiment. With the file references received from the leaf index systems 110 (e.g., through the heartbeat information 115), the root index logic 110 generates and populates the root directory 114, according to one embodiment. If the heartbeat information 115 from multiple leaf index systems 110 provides conflicting information (e.g., 2 different files with the same path and the same name), the root index system 108 may be configured to generate an alert or other message to the leaf index systems 110 and/or to a user or administrator, according to one embodiment.

The root directory 114 includes file references 116, leaf index references 118, and leaf index systems status 121, according to one embodiment. The root directory 114 is a tree data structure that functions as a root index for file references and leaf index systems, according to one embodiment. The root directory 114 maps file references 116 to the leaf index references 118 of the leaf index systems 110, which store additional information about the file references 116, according to one embodiment. In other words, the root directory 114 stores references to files that are stored in the data storage devices 112, but does not store information related to which of the data storage devices 112 is storing particular file blocks. The file references 116 include, but are not limited to, file names, file sizes, file identification numbers, file creation date and/or time, or other metadata related to the files stored in the data stores 112, according to one embodiment. The file references 116 include external system data such as which of the leaf index systems 110 is managing the file of a particular file reference, according to one embodiment. The file references 116 include external system data that is indicative of user privileges, e.g., which indicates access privileges of a particular client device or user for a particular file.

The root directory 114 includes a plurality of subdirectories that are organized in a tree data structure, according to one embodiment. The root directory 114 associates the file references 116 with particular ones of the leaf index references 118 within the tree data structure, according to one embodiment. The root directory 114 may implement directory-level associations or file-level associations, to associate the file references 116 with the leaf index references 118, according to one embodiment. For example, each subdirectory or directory in the root directory 114 may be assigned or associated with a single one of the leaf index systems 110, so that any file references included in a particular subdirectory or directory are managed by the assigned single one of the leaf index systems, according to one embodiment. In another implementation, each of the file references 116 includes metadata that includes one of the leaf index references 118 to indicate which of the leaf index systems 110 is responsible for managing that particular file reference.

The leaf index references 118 include information that identifies which of the leaf index systems 110 maintains additional information about the file references 116, according to one embodiment. For example, for a first of the file references 116, the root directory 114 may cause the metadata for a first of the leaf index references 118 to indicate that the first of the file references 116 is maintained by the leaf index system 110m, according to one embodiment. Accordingly, the root index system 108 can delegate access operations for a file to the leaf index system 110m without maintaining information about the storage location of a particular file. When a client device 102a requests information from the file, the root index system 108 identifies one of the leaf index systems 110 that maintains information about the requested file, and connects the client device 102a with the relevant one of the leaf index systems 110, after which, the relevant leaf index system 110 provides information to the client device 102a that enables the client device 102a to directly read, update, or otherwise access the requested file directly from one of the data storage devices 112, according to one embodiment.

The leaf index systems status 121 is a table, another data structure, or an attribute of the file references 116 that indicates the operable status and available capacity of the leaf index systems 110, according to one embodiment. The root index system 108 (e.g., the root index logic 113) updates the leaf index systems status 121 in response to receipt of the heartbeat information 115, according to one embodiment.

Each of the leaf index systems 110 includes leaf index logic 119 (individually, leaf index logic 119a through leaf index logic 119m), and a leaf directory 120 (individually, leaf directory 120a through leaf directory 120m), according to one embodiment. The leaf index logic 119 enables the leaf index systems 110 to provide the heartbeat information 115 to the root index system 108, according to one embodiment. The leaf index logic 119 also causes the leaf index system 110 to generate the leaf directory 120, according to one embodiment.

The leaf directories 120 include file references 122 (individually, file references 122a through file references 122m) and block references 124 (individually, block references 124a through block references 124m), according to one embodiment. The leaf directories 120 are tree data structure that function as a leaf indexes, according to one embodiment. Each of the leaf directories 120 have parent directories and subdirectories that are similar to the hierarchy of the root directory 114, according to one embodiment. Each of the leaf directories 120 may include directories and subdirectories that only partially mirror the hierarchy of the root directory 114, for example, with directories and subdirectories that are relevant to the file references 122 that are stored by the particular leaf index systems 110, according to one embodiment. The leaf directories 120 associate the file references 122 with block references 124, according to one embodiment. The file references 122 may be similar to the file references 116, according to one embodiment. The file references 122 (e.g., the file reference 122a) include, but are not limited to file metadata such as creation time, size, or other file identification information, according to one embodiment. The file references 122 include attributes that include corresponding ones of the block references 124, according to one embodiment. In other words, the file references 122 include attributes that indicate which block files and which of the data storage devices 112 include the files that are referenced by the file references 122, according to one embodiment.

The block references 124 identify which one or more data storage devices 112 store the files associated with the file references 122, according to one embodiment. The block references 124 may include, but are not limited to, block addresses, block address offsets, file sizes, block file identifiers, data store identifiers, Internet protocol (“IP”) addresses of data storage devices 112, etc. By maintaining file references 122 instead of the files themselves, the leaf index systems 110 are able to store relationships (e.g., in a tree data structure) between the file references 122 and the block file references 124 and are able to provide information to the client devices 102 that enable the client devices 102 to directly access (e.g., read, write, update) the files stored in the data storage devices 112, according to one embodiment.

The data storage devices 112 are memory systems having block files 126 (individually, block files 126a through block files 126nn) and files 128 (individually, files 128a through files 128nn), according to one embodiment. The files 128 are the objects that are referenced by the file references 122, according to one embodiment. The data storage devices 112 may include a solid-state drive (SSD), a hard disk drive (HDD), a network attached storage (NAS) system, a storage area network (SAN) and/or a redundant array of independent disks (RAID) systems, optical disks, storage devices that are coming on the market such as non-volatile memory such as 3D-Xpoint, and cloud S3 (Simple Storage Service) end-points. The data storage devices 112 provide heartbeat information to the leaf index systems 110 to enable the leaf index logic 119 to update the leaf directories 120, according to one embodiment. Based on the heartbeat information received from the data storage devices 112, the leaf index systems 110 determine their own capacity and availability for receiving additional files (e.g., through write operations), according to one embodiment.

The memory circuitry 106 may include volatile memory (e.g., RAM) and may include non-volatile memory (e.g., NAND flash). The memory circuitry 106 may be or may include memory devices that use chalcogenide glass, multi-threshold level NAND flash memory, NOR flash memory, single or multi-level Phase Change Memory (PCM), a resistive memory, nanowire memory, ferroelectric transistor random access memory (FeTRAM), anti-ferroelectric memory, magnetoresistive random access memory (MRAM) memory that incorporates memristor technology, resistive memory including the metal oxide base, the oxygen vacancy base and the conductive bridge Random Access Memory (CB-RAM), or spin transfer torque (STT)-MRAM, a spintronic magnetic junction memory based device, a magnetic tunneling junction (MTJ) based device, a DW (Domain Wall) and SOT (Spin Orbit Transfer) based device, a thyristor based memory device, or a combination of any of the above, or other memory. The memory device may refer to the die itself and/or to a packaged memory product. The data storage devices 112 may include memory similar to the memory circuitry 106. The memory circuitry 106 may include, but is not limited to, a NAND flash memory (e.g., a Triple Level Cell (TLC) NAND or any other type of NAND (e.g., Single Level Cell (SLC), Multi-Level Cell (MLC), Quad Level Cell (QLC), etc.)), NOR memory, solid state memory (e.g., planar or three Dimensional (3D) NAND flash memory or NOR flash memory), storage devices that use chalcogenide phase change material (e.g., chalcogenide glass), byte addressable nonvolatile memory devices, ferroelectric memory, silicon-oxide-nitride-oxide-silicon (SONOS) memory, polymer memory (e.g., ferroelectric polymer memory), byte addressable random accessible 3D crosspoint memory, ferroelectric transistor random access memory (Fe-TRAM), magnetoresistive random access memory (MRAM), phase change memory (PCM, PRAM), resistive memory, ferroelectric memory (F-RAM, FeRAM), spin-transfer torque memory (STT), thermal assisted switching memory (TAS), millipede memory, floating junction gate memory (FJG RAM), magnetic tunnel junction (MTJ) memory, electrochemical cells (ECM) memory, binary oxide filament cell memory, interfacial switching memory, battery-backed RAM, ovonic memory, nanowire memory, electrically erasable programmable read-only memory (EEPROM), etc. In some embodiments, the byte addressable random accessible 3D crosspoint memory may include a transistor-less stackable cross point architecture in which memory cells sit at the intersection of words lines and bit lines and are individually addressable and in which bit storage is based on a change in bulk resistance.

The processor circuitry 105 may include, but is not limited to, a microcontroller, an application-specific integrated circuit (ASIC), a programmable logic device (PLD), a complex PLD, etc.

The communication circuitry 107 for communicating to the client devices 102, according to one embodiment. The communication circuitry 107 may include network cards, Wi-Fi radios, WiGig, cellular radios, antennas, communications ports, firmware, software and hardware to support communications with one or more of the client devices 102 and/or communications between the root index system 108, the leaf index systems 110, and the data storage devices 112, according to one embodiment.

The hardware (“HW”) circuitry 125 (individually, HW circuitry 125a through 125m) may include processor circuitry, memory circuitry, and communication circuitry that is similar to and that may be distinct from the processor circuitry 105, the memory circuitry 106, and the communication circuitry 107, according to one embodiment.

The hardware (“HW”) circuitry 129 (individually, HW circuitry 129a through 129nn) may include processor circuitry, memory circuitry, and communication circuitry that is similar to and that may be distinct from the processor circuitry 105, the memory circuitry 106, and the communication circuitry 107, according to one embodiment.

The disclosed file system 104 facilitates the expansion of the file references 116, 122 with the simple addition of data storage devices 112 or additional leaf index systems 110, according to one embodiment. To expand the file system 104, an administrator may configure a new one of the leaf index systems 110 to communicate with one or more data storage devices 112, and may provide the new one of the leaf index systems 110 with credentials to provide heartbeat information 115 to the root index system 108, according to one embodiment. In response, the root index system 108 may be configured to have a discovery mode, in which case, the root index system 108 adds the new one of the leaf index systems 110 to the root directory 114 as additional resource to which files may be written, according to one embodiment. In another implementation, the root index system 108 is configured to add additional leaf index systems 110 once a new one of the leaf index systems 110 is configured into the root index logic 113, according to one embodiment.

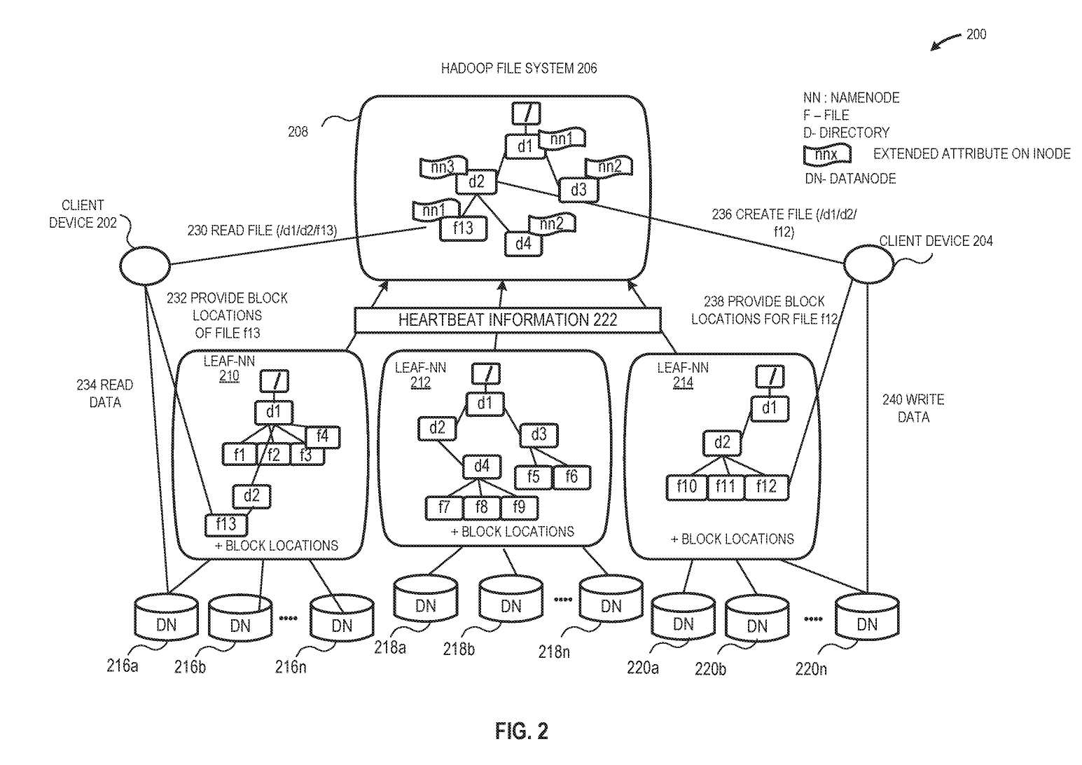

FIG. 2 illustrates a diagram of a data management system 200 that includes a client device 202 and a client device 204 communicating with a Apache™ Hadoop® file system 206, according to one embodiment. The Apache™ Hadoop® file system 206 is one specific implementation of the file system 104 (shown in FIG. 1), according to one embodiment. The Apache™ Hadoop® file system 206 includes a root namenode 208, a leaf namenode (“NN”) 210, a leaf namenode 212, a leaf namenode 214, and datanodes 216, 218, and 220, according to one embodiment.

The data management system 200 of FIG. 2 illustrates an example of the client device 202 reading a file f13 from the Apache™ Hadoop® file system 206, and illustrates an example of the client device 204 writing a file f12 to the Apache™ Hadoop® file system 206, consistent with several embodiments of the present disclosure.

The root namenode 208 includes a directory that is used to map the leaf namenodes 210, 212, 214 to files stored in the datanodes 216, 218, and 220, according to one embodiment. The root namenode 208 is one example implementation of the root index system 108, according to one embodiment. The root namenode 208 omits block location information and omits datanode information. The root name node 208 does not include information about which datanodes store files, this information is managed by the leaf namenodes. By omitting datanode information from the root namenode 208, the root namenode 208 becomes capable of mapping billions of file references to several (e.g., tens or hundreds) of leaf namenodes, according to one embodiment.

The root namenode 208 includes a directory hierarchy that organizes relationships between file references (e.g., f13) and the leaf namenodes 210, 212, and 214, according to one embodiment. In the illustrated example of the root namenode 208, a root directory “/” includes a first subdirectory (“d1)”, according to one direct embodiment. The first subdirectory d1 is associated with the leaf namenode 210, so any file references that are mapped to the first subdirectory d1 are stored by leaf namenode 210, according to one embodiment.

The subdirectory d1 includes a second subdirectory (“d2”) and a third subdirectory (“d3”), according to one embodiment. The second subdirectory d2 is associated with the leaf namenode 214, therefore, any file references (e.g., f10, f11, f12) stored in the second subdirectory d2 are associated with the leaf namenode 214. The third subdirectory d3 is associated with the leaf namenode 212, so any file references stored in the third subdirectory d3 are managed by the leaf namenode 212, according to one embodiment. The fourth subdirectory (“d4”) is associated with the leaf namenode 212, according to the illustrated example implementation.

The root namenode 208 is configured to handle exceptions to typical operations for the leaf namenodes 210, 212, and 214. The file reference for the file f13 is an illustrative example of exception handling by the root namenode 208, according to one embodiment. If leaf namenode 214 (“nn3”) is configured to manage files under the second subdirectory d2, the root namenode 208 may redirect a write attempt if the leaf namenode 214 runs out of available space. For example, if a client device (e.g., 202) attempts to write an additional file (e.g., f13) to the second subdirectory d2, while the leaf namenode 214 is out of available space, the root namenode 208 may add a file reference for the file f13 to the root namenode directory and may assign the file attributes for the file reference to be assigned to a leaf namenode that has available space. For example, the root namenode 208 may assign the leaf namenode 210 to the attributes (e.g., the extended attributes) of the file reference for the file f13, so that the leaf namenode 210 manages the file reference for the file f13, even though the remaining file references under the second subdirectory d2 are managed by the leaf namenode 214, according to one embodiment. This exception handling feature allows a user to continue to save a file or move a file to a subdirectory of the user's choosing, even if the leaf namenode that manages the particular subdirectory has run out of available space.

In one embodiment, the root namenode 208 supports low bandwidth file transfers between directories. If the root namenode 208 receives a request to move a file (e.g., f7) from a directory (e.g., d4) that is managed by one leaf namenode (e.g., leaf namenode 212) to a directory (e.g., d2) that is managed by another leaf namenode (e.g., leaf namenode 214), the root namenode 208 may update the root namenode directory (under subdirectory d4) with a pointer to the leaf namenode (e.g., leaf namenode 212) that is already storing the file reference of the file to be moved. For the user, it may appear as though the file (e.g., f7) has been moved from one directory (e.g., d4) to another directory (e.g., d2), when in actuality, the root namenode directory has been modified without modifying the leaf namenodes that managed the file reference of the file to be moved (e.g., f7), according to one embodiment.

The leaf namenodes 210, 212, and 214 are example implementations of the leaf index systems 110 (shown in FIG. 1), according to one embodiment. The leaf namenodes 210, 212, and 214 include the directory (e.g., fully or partially) stored by the root namenode 208, according to one embodiment. However, each of the leaf namenodes 210, 212, 214, are limited to maintaining the files references and block (or memory) references that they have individually been assigned or associated with or assigned to maintain, according to one embodiment. For example, the leaf namenode 210 is assigned the first directory d1 and the file or file reference f13, therefore, the leaf namenode 210 includes file references for files that are stored under the first directory d1 and includes a file reference for the file f13, which is stored under the directory d2, according to one embodiment. Furthering the example, the leaf namenode 212 is assigned the third directory d3 and the fourth directory d4, therefore, the leaf namenode 212 includes file references for the files (e.g., f5, f6, f7, f8, f9) that are stored under the third subdirectory d3 and under the fourth subdirectory d4, according to one embodiment. For example, the leaf namenode 214 is assigned the second subdirectory d2 by the root namenode 208, therefore, the leaf namenode 214 includes file references for the files (e.g., f10, f11, f12) that are stored under the second subdirectory d2, according to one embodiment. It should be noted that, as described and illustrated in FIG. 1, the block references (e.g., the block locations, the data storage device IP addresses) for each of the file references is also stored in the leaf namenodes 210, 212, and 214, according to one embodiment. The block storage references are stored as attributes of the file references in the leaf namenodes 210, 212, and 214, according to one embodiment.

The datanodes 216, 218, and 220 are example implementations of the data storage devices 112 (shown in FIG. 1), according to one embodiment. The datanodes 216, 218, and 220, can each be assigned or allocated to support one or more of the leaf namenodes 210, 212, and 214, according to one embodiment. For illustrative purposes, the datanodes 216 (individually, 216a, 216b, through 216n) are associated with or allocated to storing files that are managed by the leaf namenode 210, according to one embodiment. The datanodes 218 (individually, 218a, 218b, through 218n) are associated with or allocated to storing files that are maintained by the leaf namenode 212, according to one embodiment. The datanodes 220 (individually, 220a, 220b, through 220n) are associated with or allocated to storing files that are maintained by the leaf namenode 214, according to one embodiment.

As new files are stored to datanodes associated with one or more particular leaf namenodes, the leaf namenode that experiences the change provides updated information to the root namenode through the heartbeat information 222, according to one embodiment. When the root namenode 208 receives the heartbeat information 222, the root namenode updates the directory with the file reference and associates the file reference with the particular leaf namenode, according to one embodiment. The root namenode delegates updates to leaf namenodes synchronously or asynchronously when a request to write, move, delete, or update a file is made by the client device 202 or the client device 204, according to one embodiment.

The data management system 200 illustrates a read file operation for the file f13, according to one embodiment. At operation 230, the client device 202 submits a request to read a file f13 to the root namenode 208, according to one embodiment. The request to read the file f13 includes a directory (e.g., /d1/d2/) and a file name (e.g., f13) of the file to be read, according to one embodiment. The root namenode 208 determines that the file d13 is maintained by the leaf namenode 210, according to one embodiment. In one embodiment, the root namenode 208 identifies a relevant leaf namenode by reading attributes of a subdirectory (e.g., attributes of subdirectory d2). In one embodiment, the root namenode 208 identifies a relevant leaf namenode by reading attributes of a file reference, for example, for the file f13. The root namenode 208 provides to the client device 202 that the client device 202 needs to communicate with the leaf namenode 210 to obtain a block reference (e.g., a block address, an IP address, a block location and offset, etc.) for the file f13 from the leaf namenode 210, according to one embodiment. At operation 232, the leaf namenode 210 provides the block locations within the datanode 216 for the file f13, according to one embodiment. At operation 234, the client device 202 communicates directly with one or more of the datanodes 216 to read the data corresponding to the file f13, according to one embodiment.

The data management system 200 illustrates a write file operation for the file f12, according to one embodiment. At operation 236 client device 204 submits a request to create a file f12 to the root namenode 208, according to one embodiment. The request includes a file name (e.g., f12) and a directory (e.g., /d1/d2/) in which to create the file, according to one embodiment. The root namenode 208 receives directory to which the client device 204 requests to write the file f12, according to one embodiment. The root namenode 208 updates the directory (the second subdirectory d2) with the file reference for the file f12 and associates the file reference for the file f12 with the leaf namenode 214, according to one embodiment. The root namenode 208 may determine whether a requested directory has the capacity for a write and may reject the write request based on capacity, according to one embodiment. The root namenode 208 provides instructions to the leaf namenode 214 to initiate communications with the client device 204 to complete the creation of the file f12 within the second subdirectory d2, according to one embodiment. The root namenode 208 provides access instructions to the client device 204 to access the leaf namenode 214 to write the file f12 in the second subdirectory d2, according to one embodiment. In response to the request to write the file f12, the leaf namenode 214 may determine (e.g., with leaf index logic or leaf namenode logic) one or more block locations within the datanodes 220 that may receive the file f12. At operation 238, the leaf namenode 214 provides the block locations to the client device 204, according to one embodiment. At operation 240, the client device 204 communicates directly with the one or more of the datanodes 220 to write the file f12 to one or more of the datanodes 220, according to one embodiment.

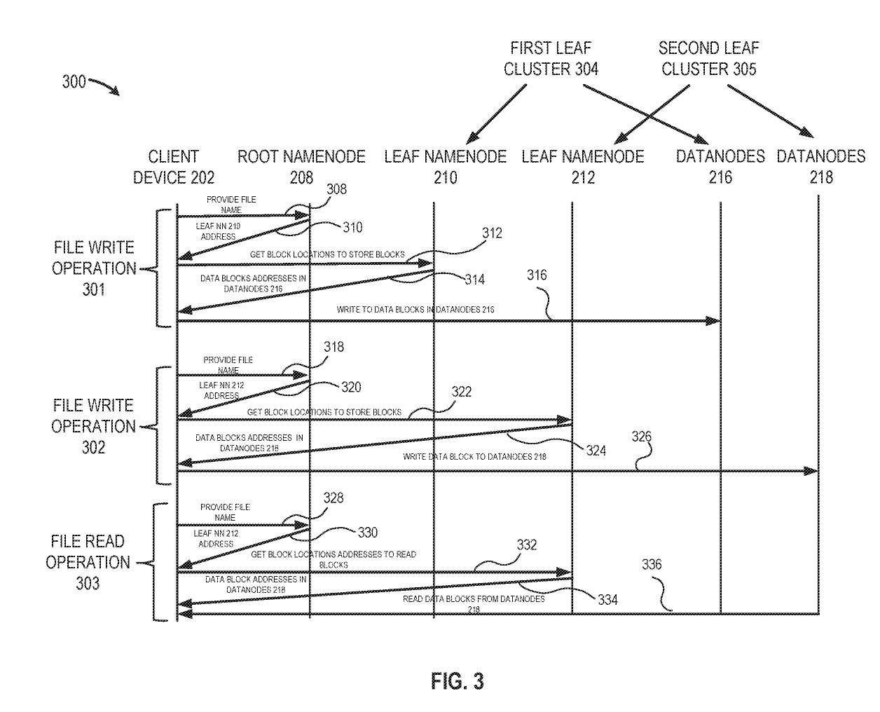

FIG. 3 is a flowchart of a process 300 operations of a data management system having a file system framework that may support a distributed processing system consistent with several embodiments of FIGS. 1 and 2. Although a particular sequence of steps is illustrated and described, one or more of the illustrated and described steps may be performed in one or more other sequences, according to various other embodiments. The process 300 includes a file write operation 301, a file write operation 302, and a file read operation 303 that utilizes a first leaf cluster 304 and a second leaf cluster 305, according to one embodiment. The first leaf cluster 304 includes the leaf namenode 210 (shown in FIG. 2) and the datanodes 216 (shown in FIG. 2), according to one embodiment. The second leaf cluster 305 includes the leaf namenode 212 and the datanodes 218 (shown in FIG. 2), according to one embodiment. The process 300 performs operations between the client device 202, the root namenode 208, the leaf namenode 210, the leaf namenode 212, the datanodes 216, and the datanodes 218, according to one illustrative example.

At operation 308, the process 300 begins the file write operation 301, and the client device 202 transmits a write request to the root namenode 208 by providing a file name of a first file, according to one embodiment. The write request includes a directory name, according to one embodiment.

At operation 310, the root namenode 208 responds to the client device 202 with an address for the leaf namenode 210, according to one embodiment.

At operation 312, the client device 202 transmits a request to the leaf namenode 210 to receive block file locations to store blocks of data that are representative of a first file, according to one embodiment.

At operation 314, the leaf namenode 210 provides to the client device 202 a reference to the datanode 216, to which the client device 202 is to write the first file, according to one embodiment. The reference may include addresses of one or more data blocks to which to write the first file.

At operation 316, the client device 202 writes the first file to one or more data blocks in one or more of the datanodes 216, according to one embodiment.

At operation 318, the process 300 begins the file write operation 302, and the client device 202 transmits a write request to the root namenode 208 by providing a file name of a second file, according to one embodiment.

At operation 320, the root namenode 208 responds to the client device 202 with an address for the leaf namenode 212, according to one embodiment.

At operation 322, the client device 202 transmits a request to the leaf namenode 212 to receive block file locations to store blocks of data that are representative of a second file, according to one embodiment.

At operation 324, the leaf namenode 212 provides to the client device 202 a reference to the datanode 218, to which the client device 202 may write the second file, according to one embodiment. The reference may include addresses of one or more data blocks to which to write the second file.

At operation 326, the client device 202 writes one or more data blocks to the datanodes 218, according to one embodiment.

At operation 328, the process 300 begins the file read operation 303, and the client device 202 transmitting a read request to the root namenode 208 by providing a file name of a third file, according to one embodiment.

At operation 330, the root namenode 208 responds to the client device 202 with an address for the leaf namenode 212, according to one embodiment.

At operation 332, the client device 202 transmit a request to the leaf namenode 212 to receive block file locations that store blocks of data that are representative of the third file, according to one embodiment. The request may include a directory and a file name.

At operation 334, the leaf namenode 212 provides the client device 202 with a reference to the datanode 218, at which the client device 202 may read the third file, according to one embodiment.

At operation 336, the client device 202 reads one or more data blocks from the datanodes 218 to read the third file, according to one embodiment.

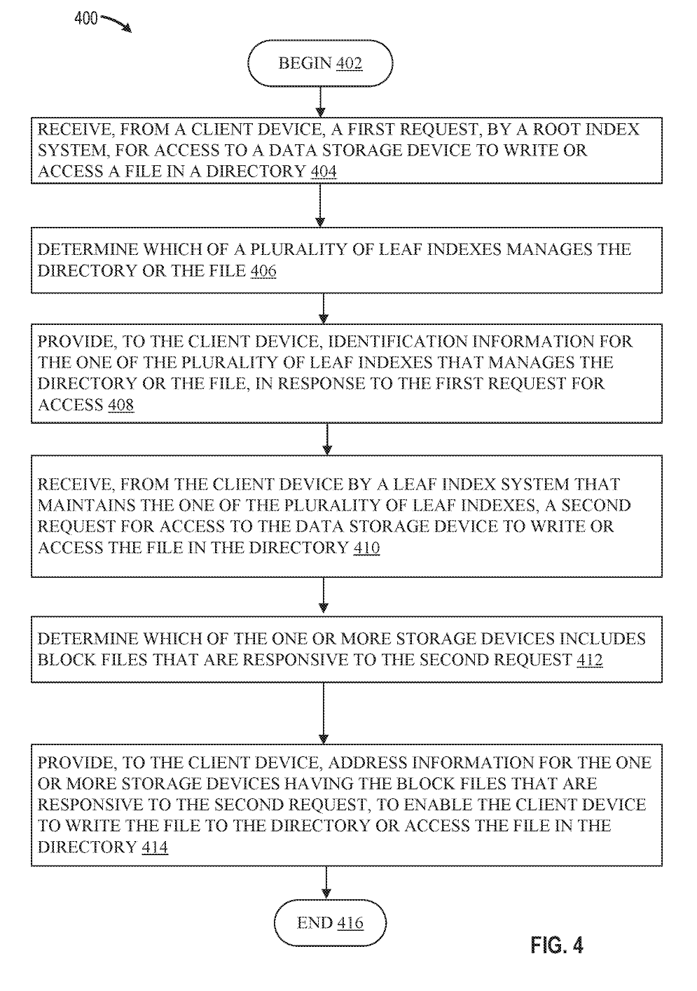

FIG. 4 is a flowchart of a process 400 process for providing a tree-based indexing framework that enables expansion of a file system, according to one embodiment.

At operation 402, the process 400 begins. Operation 402 may proceed to operation 404.

At operation 404, the process 400 includes receiving, from a client device, a first request, by a root index system, for access to a data storage device to write or access a file in a directory, according to one embodiment. Operation 404 may proceed to operation 406.

At operation 406, the process 400 includes determining which of a plurality of leaf indexes manages the directory or the file, according to one embodiment. Operation 406 may proceed to operation 408.

At operation 408, the process 400 includes providing, to the client device, identification information for the one of the plurality of leaf indexes that manages the directory or the file, in response to the first request for access, according to one embodiment. Operation 408 may proceed to operation 410.

At operation 410, the process 400 includes receiving, from the client device, a second request, by a leaf index system that maintains the one of the plurality of leaf indexes that manages the directory of the file, for access to the data storage device to write or access the file in the directory, according to one embodiment. Operation 410 may proceed to operation 412.

At operation 412, the process 400 includes determining which of the one or more storage devices includes block files that are responsive to the second request, according to one embodiment. Operation 412 may proceed to operation 414.

At operation 414, the process 400 includes providing, to the client device, address information for the one or more storage devices having the block files that are responsive to the second request, to enable the client device to write the file to the directory or access the file in the directory, according to one embodiment. Operation 414 may proceed to operation 416.

At operation 416, the process 400 ends.

While the flowcharts of FIGS. 3 and 4 illustrate operations according various embodiments, it is to be understood that not all of the operations depicted in FIGS. 3 and 4 are necessary for other embodiments. In addition, it is fully contemplated herein that in other embodiments of the present disclosure, the operations depicted in FIGS. 3 and 4 and/or other operations described herein may be combined in a manner not specifically shown in any of the drawings, and such embodiments may include less or more operations than are illustrated in FIGS. 3 and 4. Thus, claims directed to features and/or operations that are not exactly shown in one drawing or table are deemed within the scope and content of the present disclosure.

As used in any embodiment herein, the term “logic” may refer to an app, software, firmware and/or circuitry configured to perform any of the aforementioned operations. Software may be embodied as a software package, code, instructions, instruction sets and/or data recorded on non-transitory computer readable storage medium. Firmware may be embodied as code, instructions or instruction sets and/or data that are hard-coded (e.g., nonvolatile) in memory devices.

“Circuitry,” as used in any embodiment herein, may comprise, for example, singly or in any combination, hardwired circuitry, programmable circuitry, state machine circuitry, logic and/or firmware that stores instructions executed by programmable circuitry. The circuitry may be embodied as an integrated circuit, such as an integrated circuit chip. In some embodiments, the circuitry may be formed, at least in part, by the processor circuitry 105 executing code and/or instructions sets (e.g., software, firmware, etc.) corresponding to the functionality described herein, thus transforming a general-purpose processor into a specific-purpose processing environment to perform one or more of the operations described herein. In some embodiments, the various components and circuitry of the memory controller circuitry or other systems may be combined in a system-on-a-chip (SoC) architecture.

The foregoing provides example system architectures and methodologies, however, modifications to the present disclosure are possible. The processors may include one or more processor cores and may be configured to execute system software. System software may include, for example, an operating system. Device memory may include I/O memory buffers configured to store one or more data packets that are to be transmitted by, or received by, a network interface.

Any operating system of the root index system or of the leaf index system may be configured to manage system resources and control tasks that are run on, e.g., the file system device 104. For example, the OS may be implemented using Microsoft® Windows®, HP-UX®, Linux®, or UNIX®, although other operating systems may be used. In another example, the OS may be implemented using Android™, iOS, Windows Phone® or BlackBerry®. In some embodiments, the OS may be replaced by a virtual machine monitor (or hypervisor) which may provide a layer of abstraction for underlying hardware to various operating systems (virtual machines) running on one or more processing units. The operating system and/or virtual machine may implement a protocol stack. A protocol stack may execute one or more programs to process packets. An example of a protocol stack is a TCP/IP (Transport Control Protocol/Internet Protocol) protocol stack comprising one or more programs for handling (e.g., processing or generating) packets to transmit and/or receive over a network.

The memory circuitry 106 may include one or more of the following types of memory: semiconductor firmware memory, programmable memory, nonvolatile memory, read only memory, electrically programmable memory, random access memory, flash memory, magnetic disk memory, and/or optical disk memory. Either additionally or alternatively memory circuitry may include other and/or later-developed types of computer-readable memory.

Embodiments of the operations described herein may be implemented in a computer-readable storage device having stored thereon instructions that when executed by one or more processors perform the methods. The processor may include, for example, a processing unit and/or programmable circuitry. The computer-readable storage device may include a machine readable storage device including any type of tangible, non-transitory storage device, for example, any type of disk including floppy disks, optical disks, compact disk read-only memories (“CD-ROMs”), compact disk rewritables (“CD-RWs”), and magneto-optical disks, semiconductor devices such as read-only memories (“ROMs”), random access memories (“RAMs”) such as dynamic and static RAMs, erasable programmable read-only memories (“EPROMs”), electrically erasable programmable read-only memories (“EEPROMs”), flash memories, magnetic or optical cards, or any type of computer-readable storage devices suitable for storing electronic instructions. One or more of the disclosed embodiments may be implemented in Java and/or may run in Java, according to one embodiment.

### EXAMPLES

Examples of the present disclosure include subject material such as a file system, a data management system and a method related to expandable tree-based indexing framework that enables expansion of the Apache™ Hadoop® distributed file system, as discussed below.

### Example 1

According to this example there is provided a file system. The file system may include: root index logic to maintain a root index, the root index to associate a plurality of file references to a plurality of leaf index references, wherein the plurality of file references represent a plurality of files and the plurality of leaf index references represent a plurality of leaf indexes, wherein the root index and the plurality of leaf indexes are a tree data structure, wherein the root index is a parent node in the tree data structure and each of the plurality of leaf indexes is a child node in the tree data structure; and leaf index logic to maintain one of the plurality of leaf indexes, the one of the plurality of leaf indexes to associate at least one of the plurality of file references to at least one block location in one or more data storage devices, the leaf index logic to communicate the at least one block location to one or more client devices, in response to one or more requests from the one or more client devices to access data files associated with the at least one of the plurality of file references.

### Example 2

This example includes the elements of example 1, wherein the root index logic may receive, from the one or more client devices, access requests to the one or more data storage devices; determine which of the plurality of leaf indexes manage the one or more storage devices associated with the access requests; and provide, to the one or more client devices, address information for the plurality of leaf indexes that manage the one or more storage devices associated with the access requests, in response to the access requests.

### Example 3

This example includes the elements of example 1, wherein the leaf index logic may receive, from the one or more client devices, access requests to the one or more data storage devices; determine which of one or more block files is responsive to the access requests; and provide, to the one or more client devices, address information for the one or more storage devices having the one or more block files that are responsive to the access requests, in response to the access requests.

### Example 4

This example includes the elements of example 1, wherein the root index logic may receive, from the one or more client devices, access requests for at least one of the plurality of files; determine which of the plurality of leaf indexes manage the at least one of the plurality of files of the access requests; and provide, to the one or more client devices, address information for the plurality of leaf indexes that manage the at least one of the plurality of files of the access requests, in response to the access requests.

### Example 5

This example includes the elements of example 1, wherein the leaf index logic may receive, from the one or more client devices, access requests to the at least one of the plurality of files; determine which of the one or more storage devices includes block files that store the at least one of the plurality of files; and provide, to the one or more client devices, address information for the one or more storage devices having the block files that store the at least one of the plurality of files.

### Example 6

This example includes the elements of example 1, wherein the root index to associate the plurality of file references to the plurality of leaf index references may include: the root index to map each of the leaf index references to subsets of the plurality of file references.

### Example 7

This example includes the elements of example 1, wherein the root index may maintain a directory of the plurality of file references, the directory may include a root node and a plurality of subdirectory children nodes, wherein each of the plurality of subdirectory children nodes that includes at least one of the plurality of file references is assigned to one of the plurality of leaf indexes and includes one of the plurality of leaf index references.

### Example 8

This example includes the elements of example 1, wherein the root index is a root namenode that is operable within Apache™ Hadoop® file system.

### Example 9

This example includes the elements of example 1, wherein each of the plurality of leaf indexes is a leaf namenode that is operable within a Apache™ Hadoop® file system.

Example 10

This example includes the elements of example 1, wherein each of the plurality of leaf indexes is hosted by one of a plurality of leaf index systems that each include leaf node logic to maintain association between a subset of the plurality of file references and at least one block location within the one or more data storage devices.

### Example 11

This example includes the elements of example 1, wherein the root index logic to be copied to random access memory during operation of the file system.

### Example 12

This example includes the elements of example 1, wherein each of the plurality of leaf indexes is hosted by one of a plurality of leaf index systems that each include leaf node logic to transmit heartbeat information to the root index logic, wherein the root index logic to update the root index at least partially based on the heartbeat information.

### Example 13

This example includes the elements of example 1, wherein each of the plurality of file references includes one or more of a file name, a numeric file identifier, a file size, or a file time stamp.

### Example 14

This example includes the elements of example 1, wherein each of the plurality of leaf index references includes one or more of a leaf index name, or a leaf index internet protocol (IP) address.

### Example 15

This example includes the elements of example 1, wherein the at least one block location includes one or more of a block location address and offset, an address for one or more blocks or memory, or a data storage device address.

### Example 16

According to this example there is provided a data management system. The data management system may include processor circuitry; memory circuitry; and a file system. The file system may include root index logic to maintain a root index, the root index to associate a plurality of file references to a plurality of leaf index references, wherein the plurality of file references represent a plurality of files and the plurality of leaf index references represent a plurality of leaf indexes, wherein the root index and the plurality of leaf indexes are a tree data structure, wherein the root index is a parent node in the tree data structure and each of the plurality of leaf indexes is a child node in the tree data structure; and leaf index logic to maintain one of the plurality of leaf indexes, the one of the plurality of leaf indexes to associate at least one of the plurality of file references to at least one block location in one or more data storage devices, the leaf index logic to communicate the at least one block location to one or more client devices, in response to one or more requests from the one or more client devices to access data files associated with the at least one of the plurality of file references.

### Example 17

This example includes the elements of example 16, wherein the root index logic may receive, from the one or more client devices, access requests for at least one of the plurality of files; determine which of the plurality of leaf indexes manage the at least one of the plurality of files of the access requests; and provide, to the one or more client devices, address information for the plurality of leaf indexes that manage the at least one of the plurality of files of the access requests, in response to the access requests.

### Example 18

This example includes the elements of example 16, wherein the leaf index logic may receive, from the one or more client devices, access requests to the at least one of the plurality of files; determine which of the one or more storage devices includes block files that store the at least one of the plurality of files; and provide, to the one or more client devices, address information for the one or more storage devices having the block files that store the at least one of the plurality of files.

### Example 19

This example includes the elements of example 16, wherein the root index is a root namenode that is operable within Apache™ Hadoop® file system.

### Example 20

This example includes the elements of example 16, wherein each of the plurality of leaf indexes is a leaf namenode that is operable within a Apache™ Hadoop® file system.

### Example 21

This example includes the elements of example 16, wherein each of the plurality of leaf indexes is hosted by one of a plurality of leaf index systems that each include leaf node logic to transmit heartbeat information to the root index logic, wherein the root index logic to update the root index at least partially based on the heartbeat information.

### Example 22

According to this example there is provided a computer readable storage device having stored thereon instructions that when executed by one or more processors result in operations. The operations may include receive, from a client device, a first request, by a root index system, for access to a data storage device to write or access a file in a directory; determine which of a plurality of leaf indexes manages the directory or the file; provide, to the client device, identification information for the one of the plurality of leaf indexes that manages the directory or the file, in response to the first request for access; receive, from the client device and by a leaf index system that maintains the one of the plurality of leaf indexes, a second request for access to the data storage device to write or access the file in the directory; determine which of the one or more storage devices includes block files that are responsive to the second request; and provide, to the client device, address information for the one or more storage devices having the block files that are responsive to the second request, to enable the client device to write the file to the directory or access the file in the directory.

### Example 23

This example includes the elements of example 22, wherein the root index system is a root namenode that is operable within Apache™ Hadoop® file system.

### Example 24

This example includes the elements of example 22, wherein the leaf index system is a leaf namenode that is operable within a Apache™ Hadoop® file system.

### Example 25

This example includes the elements of example 22, wherein the at least one block location includes one or more of a block location address and offset, an address for one or more blocks or memory, or a data storage device address.

### Example 26

According to this example there is provided a method. The method may include receiving, from a client device, a first request, by a root index system, for access to a data storage device to write or access a file in a directory; determining which of a plurality of leaf indexes manages the directory or the file; providing, to the client device, identification information for the one of the plurality of leaf indexes that manages the directory or the file, in response to the first request for access; receiving, from the client device and by a leaf index system that maintains the one of the plurality of leaf indexes, a second request for access to the data storage device to write or access the file in the directory; determining which of the one or more storage devices includes block files that are responsive to the second request; and providing, to the client device, address information for the one or more storage devices having the block files that are responsive to the second request, to enable the client device to write the file to the directory or access the file in the directory.

### Example 27

This example includes the elements of example 26, wherein the root index system is a root namenode that is operable within Apache™ Hadoop® file system.

### Example 28

This example includes the elements of example 26, wherein the leaf index system is a leaf namenode that is operable within a Apache™ Hadoop® file system.

### Example 29

This example includes the elements of example 26, wherein the at least one block location includes one or more of a block location address and offset, an address for one or more blocks or memory, or a data storage device address.

### Example 30

According to this example there is provided a file system. The file system may include means for receiving, from a client device, a first request, by a root index system, for access to a data storage device to write or access a file in a directory; means for determining which of a plurality of leaf indexes manages the directory or the file; means for providing, to the client device, identification information for the one of the plurality of leaf indexes that manages the directory or the file, in response to the first request for access; means for receiving, from the client device and by a leaf index system that maintains the one of the plurality of leaf indexes, a second request for access to the data storage device to write or access the file in the directory; means for determining which of the one or more storage devices includes block files that are responsive to the second request; and means for providing, to the client device, address information for the one or more storage devices having the block files that are responsive to the second request, to enable the client device to write the file to the directory or access the file in the directory.

### Example 31

This example includes the elements of example 30, wherein the root index system is a root namenode that is operable within Apache™ Hadoop® file system.

### Example 32

This example includes the elements of example 30, wherein the leaf index system is a leaf namenode that is operable within a Apache™ Hadoop® file system.

### Example 33

This example includes the elements of example 30, wherein the at least one block location includes one or more of a block location address and offset, an address for one or more blocks or memory, or a data storage device address.

Example 34

According to this example there is provided a device comprising means to perform the method of any one of examples 26 to 29.

### Example 35

According to this example there is provided computer readable storage device having stored thereon instructions that when executed by one or more processors result in operations comprising: the method according to any one of examples 26 to 29.

The terms and expressions which have been employed herein are used as terms of description and not of limitation, and there is no intention, in the use of such terms and expressions, of excluding any equivalents of the features shown and described (or portions thereof), and it is recognized that various modifications are possible within the scope of the claims. Accordingly, the claims are intended to cover all such equivalents.

Various features, aspects, and embodiments have been described herein. The features, aspects, and embodiments are susceptible to combination with one another as well as to variation and modification, as will be understood by those having skill in the art. The present disclosure should, therefore, be considered to encompass such combinations, variations, and modifications.

What is claimed is:

1. A file system, comprising:
root index logic to maintain a root index, the root index to associate a plurality of file references to a plurality of leaf index references, wherein the plurality of file references represent a plurality of files and the plurality of leaf index references represent a plurality of leaf indexes, wherein the root index and the plurality of leaf indexes are a tree data structure, wherein the root index is a parent node in the tree data structure and each of the plurality of leaf indexes is a child node in the tree data structure; and
leaf index logic to maintain one of the plurality of leaf indexes, the one of the plurality of leaf indexes to associate at least one of the plurality of file references to at least one block location in one or more data storage devices, the leaf index logic to communicate the at least one block location to one or more client devices, in response to one or more requests from the one or more client devices to access data files associated with the at least one of the plurality of file references.

2. The file system of claim 1, wherein the root index logic to:
receive, from the one or more client devices, access requests to the one or more data storage devices;
determine which of the plurality of leaf indexes manage the one or more storage devices associated with the access requests; and
provide, to the one or more client devices, address information for the plurality of leaf indexes that manage the one or more storage devices associated with the access requests, in response to the access requests.

3. The file system of claim 2, wherein the leaf index logic to:
receive, from the one or more client devices, access requests to the one or more data storage devices;
determine which of one or more block files is responsive to the access requests; and
provide, to the one or more client devices, address information for the one or more storage devices having the one or more block files that are responsive to the access requests, in response to the access requests.

4. The file system of claim 1, wherein the root index logic to:
receive, from the one or more client devices, access requests for at least one of the plurality of files;
determine which of the plurality of leaf indexes manage the at least one of the plurality of files of the access requests; and
provide, to the one or more client devices, address information for the plurality of leaf indexes that manage the at least one of the plurality of files of the access requests, in response to the access requests.

5. The file system of claim 4, wherein the leaf index logic to:
receive, from the one or more client devices, access requests to the at least one of the plurality of files;
determine which of the one or more storage devices includes block files that store the at least one of the plurality of files; and
provide, to the one or more client devices, address information for the one or more storage devices having the block files that store the at least one of the plurality of files.

6. The file system of claim 1, wherein the root index to associate the plurality of file references to the plurality of leaf index references, includes: the root index to map each of the leaf index references to subsets of the plurality of file references.

7. The file system of claim 1, wherein the root index maintains a directory of the plurality of file references, the directory includes a root node and a plurality of subdirectory children nodes, wherein each of the plurality of subdirectory children nodes that includes at least one of the plurality of file references is assigned to one of the plurality of leaf indexes and includes one of the plurality of leaf index references.

8. The file system of claim 1, wherein the root index is a root namenode that is operable within Apache™ Hadoop® file system.

9. The file system of claim 1, wherein each of the plurality of leaf indexes is a leaf namenode that is operable within a Apache™ Hadoop® file system.

10. The file system of claim 1, wherein each of the plurality of leaf indexes is hosted by one of a plurality of leaf index systems that each include leaf node logic to maintain association between a subset of the plurality of file references and at least one block location within the one or more data storage devices.

11. The file system of claim 1, wherein the root index logic to be copied to random access memory during operation of the file system.

12. The file system of claim 1, wherein each of the plurality of leaf indexes is hosted by one of a plurality of leaf index systems that each include leaf node logic to transmit heartbeat information to the root index logic, wherein the root index logic to update the root index at least partially based on the heartbeat information.

13. The file system of claim 1, wherein each of the plurality of file references includes one or more of a file name, a numeric file identifier, a file size, or a file time stamp.

14. The file system of claim 1, wherein each of the plurality of leaf index references includes one or more of a leaf index name, or a leaf index internet protocol (IP) address.

15. The file system of claim 1, wherein the at least one block location includes one or more of a block location address and offset, an address for one or more blocks or memory, or a data storage device address.

16. A data management system, comprising:
processor circuitry;
memory circuitry; and
a file system, including:
root index logic to maintain a root index, the root index to associate a plurality of file references to a plurality of leaf index references, wherein the plurality of file references represent a plurality of files and the plurality of leaf index references represent a plurality of leaf indexes, wherein the root index and the plurality of leaf indexes are a tree data structure, wherein the root index is a parent node in the tree data structure and each of the plurality of leaf indexes is a child node in the tree data structure; and
leaf index logic to maintain one of the plurality of leaf indexes, the one of the plurality of leaf indexes to associate at least one of the plurality of file references to zero block locations or to one or more block locations in one or more data storage devices,
wherein for each of the at least one of the plurality of files references that are associated with one or more block locations, the leaf index logic to communicate the one or more block locations to one or more client devices, in response to one or more requests from the one or more client devices to access data files associated with the at least one of the plurality of file references.

17. The data management system of claim 16, wherein the root index logic to:
receive, from the one or more client devices, access requests for at least one of the plurality of files;
determine which of the plurality of leaf indexes manage the at least one of the plurality of files of the access requests; and
provide, to the one or more client devices, address information for the plurality of leaf indexes that manage the at least one of the plurality of files of the access requests, in response to the access requests.

18. The data management system of claim 17, wherein the leaf index logic to:
receive, from the one or more client devices, access requests to the at least one of the plurality of files;
determine which of the one or more storage devices includes block files that store the at least one of the plurality of files; and
provide, to the one or more client devices, address information for the one or more storage devices having the block files that store the at least one of the plurality of files.

19. The data management system of claim 16, wherein the root index is a root namenode that is operable within Apache™ Hadoop® file system.

20. The data management system of claim 16, wherein each of the plurality of leaf indexes is a leaf namenode that is operable within a Apache™ Hadoop® file system.

21. The data management system of claim 16, wherein each of the plurality of leaf indexes is hosted by one of a plurality of leaf index systems that each include leaf node logic to transmit heartbeat information to the root index logic, wherein the root index logic to update the root index at least partially based on the heartbeat information.

22. A computer readable storage device having stored thereon instructions that when executed by one or more processors result in operations, comprising:
receive, from a client device, a first request, by a root index system, for access to a data storage device to write or access a file in a directory;
determine which of a plurality of leaf indexes manages the directory or the file;
provide, to the client device, identification information for the one of the plurality of leaf indexes that manages the directory or the file, in response to the first request for access;
receive, from the client device and by a leaf index system that maintains the one of the plurality of leaf indexes, a second request for access to the data storage device to write or access the file in the directory;
determine which of the one or more storage devices includes block files that are responsive to the second request; and
provide, to the client device, address information for the one or more storage devices having the block files that are responsive to the second request, to enable the client device to write the file to the directory or access the file in the directory.

23. The computer readable storage device of claim 22, wherein the root index system is a root namenode that is operable within Apache™ Hadoop® file system.

24. The computer readable storage device of claim 22, wherein the leaf index system is a leaf namenode that is operable within a Apache™ Hadoop® file system.

25. The computer readable storage device of claim 22, wherein the at least one block location includes one or more of a block location address and offset, an address for one or more blocks or memory, or a data storage device address.
